(19) United States
(12) Patent Application Publication
(10) Pub. No.: US 2003/0118792 A1
(43) Pub. Date: Jun. 26, 2003

(54) Ink jet recording sheet with modified gelatin

(75) Inventors: Paola Franceschini, Cairo Montenotte (IT); Marcella Ercoli, Varazze (IT)

Correspondence Address: MARK L. LITMAN & ASSOCIATES, York Business Center, Suite 205, 3209 West 76th Street, Edina, MN, 55435, US

(73) Assignee: Ferrania, S.p.A

(21) Appl. No.: 10/294,175

(22) Filed: Nov. 14, 2002

(30) Foreign Application Priority Data
Nov. 20, 2001 (IT) SV2001A000044

(51) Int. Cl. B41M 5/00

(52) U.S. Cl. 428/195

(57) ABSTRACT

The present invention refers to a recording medium having an ink-receiving layer comprising an alumina hydrate and an acid-processed gelatin, wherein the acid-processed gelatin is a modified gelatin with at least some blocked carboxylic groups. The viscosity of the dispersion doesn't abruptly increase and the dispersing state remains good. In addition, the use of said dispersion provides the advantage to obtain an ink-receiving layer with proper thickness, with a glossy surface and free of defects, such as cracks or microcoagulations.

### BACKGROUND OF THE INVENTION

1. Field of the Invention

This invention relates to a recording medium for ink jet printers comprising an alumina hydrate and an acid-processed modified gelatin.

2. Background of the Art

As is generally known to those skilled in the art, gelatin is prepared from collagen by means of an acid treatment or an alkali treatment. Acid treatment is effected by soaking the collagen in aqueous mineral acids (e.g., hydrochloric acid and sulfuric acid) for several hours. Alkali treatment is effected by contact with ammonia, sodium carbonate, sodium hydroxide and lime. The resulting gelatins are conventionally known as acid-processed gelatin or type A gelatin and alkali-processed gelatin or type B gelatin. Details on the preparation of gelatin are described in e.g., “the Science and Technology of Gelatin” A. G. Ward and A. Courts, Academic Press 1977, p. 295. Gelatin consists of a three-dimensional network of polypeptide chains. Each polypeptide chain is built-up by repeating units of about twenty different amino acids linked together by peptide bonds. The dicarboxylic amino acids, i.e., aspartic acid and glutamic acid, provide the free (unbonded) carboxyl groups in the polypeptide chain, while the free amino groups are provided by amino acids containing more than one amino group, e.g., lysine and arginine. Free carboxylic groups and free amino groups can act as so-called functional groups in several chemical reactions, e.g., modification reactions and hardening reactions. The ratio of free carboxylic and free amino groups determines the so-called isoelectric point, the pH at which the gelatin molecule is electrically neutral. Scientific and patent literature is replete with references concerning gelatin modifications chemically applied on the free primary amino functions. For instance, different types of acylated gelatins are disclosed in U.S. Pat. No. 2,525,753, U.S. Pat. No. 2,827,419, U.S. Pat. No. 3,486,896 and U.S. Pat. No. 3,763,138. Phthaloyl gelatins are described in U.S. Pat. No. 2,725,293 and BE 840,437. Reactions of gelatin with compounds containing active halogen atoms are disclosed in BE 614, 426 and BE 1,005,787. On the other hand, disclosures concerning modification on the free carboxyl group are scarce. However, such a modification type theoretically would offer several benefits: there are about three times as many free carboxyl groups as there are free primary amino groups on the gelatin polypeptidic chain. Also, chemical activity on the free carboxylic groups would offer the possibility of a substantially higher degree of modification, while the amino groups would remain available for other reactions, e.g., hardening. In U.S. Pat. No. 4,238,480, different reagents, such as ethylenediamine, are used to modify collagen in such a way as to make it a substance with a more electropositive surface, which is used as a hemostatic agent. U.S. Pat. No. 5,219,992 discloses a gelatin which is modified by reaction on part of the free carboxyl groups in the presence of (i) an “amide bond forming agent”, e.g., 1 -pyrrolidinylcarbonylpyridinium chloride, and (ii) a well-defined type of diamine, triamine or cyclic diamine, e.g., piperazine. In this way, additional terminal amino functions were introduced onto the gelatin molecule, which, moreover, proved to be more reactive to vinylsulfonyl hardeners, a common type of hardeners for gelatin, than the original gelatin functionalities. In this way multilayer photographic elements were designed which showed so-called differential hardness. European Patent Application No. 614,930 discloses other types of carboxyl group modified gelatin and their use in photographic elements. U.S. Pat. Nos. 5,474,885 and 5,536,817 describe a modified gelatin to be used in a diffusion transfer reversal process, wherein a portion of the free carboxyl groups is replaced by modifiers having more acid end-standing groups (e.g., terminal groups) usually chosen from —SO₃M, —OSO₃M or —SSO₃M groups, M being hydrogen or a cation. U.S. Pat. No. 5,391,477 describes a silver halide photographic element comprising at least one layer comprising modified gelatin wherein at least one carboxylic acid moiety of gelatin is modified to form a specific amide moiety. U.S. Pat. No. 5,439,791 describes new types of modified gelatins, showing an enhanced reactivity towards vinylsulfonyl hardeners, the gelatin being modified at part of the free carboxyl groups of the polypeptide chain by the introduction of a new end-standing amino, sulfinic acid or thiol group. European Patent Application No. 813,109 discloses a photographic element with improved scratch resistance having a protective layer which includes a matting agent and a modified gelatin having at least one carboyxlic acid moiety modified into a monoamide of a polyamine, whereby at least one additional amine group is introduced into the polypeptidic chain of the original gelatin.

Recording elements for inkjet printers comprising ink receiving layers containing an alumina hydrate have been proposed in recent years to meet the basic characteristic requirements of digital printing such as high ink absorptivity, high optical density and resolution and bright color. In fact, alumina hydrate has a positive surface charge resulting in excellent dye fixability. Moreover the dyes in the inks are adsorbed on the uppermost layer of the surface resulting in high color density and high reflectivity of light. Particle size and porosity of the ink receiving layers and materials in the ink receiving layers can affect the appearance of the printed images and these properties can be used to control surface gloss and to obtain clear coating.

High ink absorptivity is affected by particle size and by both internal and external porosity. The high capacity for absorbing liquid inks is also related to the thickness of the ink receiving layer which must be at least 15 microns. Considering the difficulty to obtain, with the conventional coating techniques, a thick layer with high pigment content with good productivity rates, and with the layer free of defects, it has been found in the prior art that the use in the ink-receiving layer of a water soluble polymer having gel-forming ability such as gelatin could give some advantages.

U.S. Pat. No. 5,804,320 describes a recording medium which comprises an ink-receiving layer comprising a pigment and an alkali-processed gelatin, wherein the alkali-processed gelatin has no sol-gel reversibility in a room temperature environment and the gelatin has a number average or weight average molecular weight within the range of from 50,000 to 150,000. The coating aqueous dispersion therein disclosed comprises water and has dispersed therein a pigment and the alkali-processed gelatin. The above described gelatin requires the use of a process for producing a recording medium which comprises the steps of coating on a support at room temperature the coating aqueous dispersion and drying the resulting coating at a high temperature (80° C. or above). This method, however, is too expensive and causes defects, such as cracks of the ink receiving layer, and makes it difficult to obtain a thick and uniform ink-receiving layer.

EP patent application 636,489 describes a recording medium having an ink-receiving layer which comprises an alumina hydrate and acid-processed or alkali-processed gelatin. The alumina hydrate average particle diameter described therein is in the range of from 20 to 50 nm and the pore volume of the ink-receiving layer is within a range of from 0.4 to 0.6 ml/g. However, such small average particle diameters and such small pore volumes cause a reduced efficiency in the ink drying ability of the ink-receiving layer.

The viscosity of a dispersion comprising an alumina hydrate with an average particle diameters greater than 50 nm and with a pore volume within a range of from 0.7 to 1.0 ml/g, and an acid-processed gelatin having a sol-gel reversibility is so high that such a dispersion becomes uncoatable. Consequently, a sort of incompatibility between alumina hydrate and an acid-processed gelatin is supposed.

### SUMMARY OF THE INVENTION

The present invention refers to a recording medium having an ink-receiving layer comprising an alumina hydrate and an acid-processed gelatin, wherein the acid-processed gelatin is a modified gelatin with at least some blocked carboxylic group. The invention identifies that a dispersion comprising an alumina hydrate, and an acid-processed gelatin with at least some blocked carboxylic group, presents great advantages during its preparation. In fact, with these characteristics, the viscosity of the dispersion does not abruptly increase during manufacture, coating and processing and the dispersing state remains good. This allows the coating of the dispersion by means of conventional methods, which reduces manufacturing costs without sacrificing quality. In addition, the use of such a dispersion allows one to obtain a ink-receiving layer with a proper thickness, a glossy surface that is free of defects, such as cracks or microcoagulations.

### DETAILED DESCRIPTION OF THE INVENTION

An acid-processed gelatin used in the present invention may be obtained by a treatment with hydrochloric acid or the like of collagen (e.g., ossein) previously subjected to a deliming process, by using pigskin or bovine materials or any other source of collagen as a raw material. Besides the acid-processed gelatin prepared by the above-described treatment, examples of an acid-processed gelatin used in the present invention include low-molecular weight acid-processed gelatin obtained by hydrolyzing or enzymolyzing the acid-processed gelatin prepared by the above-described treatment.

Acid processed gelatins having at least some modified carboxylic groups (e.g., esterified) used in the present invention can been prepared, for example, according to the process described in the Imaging Science Journal, Suzuki K. et al., Vol. 45, 1997, p. 102, wherein carboxylic groups were blocked by alkyl esterification. An initial gelatin solution was added to the proper alcohol with hydrochloric acid, and reacted for up to 100 hours with stirring at the reflux temperature of the mixture. After reaction, the sample solution was concentrated by evaporation; after that, the sample solution was dialyzed and concentrated by ultrafiltration, deionized by ion exchange resin, filtered and dried to produce the modified gelatin. The modified gelatin obtained according to the alkyl esterification process described by the Suzuki method comprises at least one free carboxylic group deriving from aspartic acid or glutamic acid transformed in an alkyl ester group. Useful alcohols to be employed into the alkyl esterification method are, for exemple, methanol, ethanol, propanol, benzyl alcohol, and the like.

A modified gelatin according to the practice of the present invention is defined as a gelatin in which at least a portion of the free carboxylic groups on the gelatin have been substituted, that is where at least a portion of the free hydrogens on the carboxylic groups has been replaced with a covalently bonded group.

A modified gelatin can be characterized in various ways. An important parameter is the modification degree, expressed as the percentage of modified carboxyl groups compared to the total number of free carboxyl groups present in the original gelatin. From knowledge of the amount of milli-equivalents of free carboxyl groups in the original gelatin and the concentration of the reagents, the theoretical maximal percentage of carboxyl groups that should be or are modified can be calculated. The actually obtained degree of modification can be determined from an acid-base titration. From these two values, the yield of the modification can be calculated. The modified gelatin useful in the present invention preferably comprises a percentage of blocked carboxylic groups of at least 10% relative to the total number of original free carboxylic group, more preferably of at least 20%, and most preferably of at least 50%. Another important parameter is the isoelectric point. This can be measured according to standard procedures, for example, by mixing a cation exchange resin and an anion exchange resin in a column, heating with warm water, and allowing an aqueous solution of gelatin to pass through the column. After removal of an initial effluent from the column, the pH of the gelatin can be measured. The modified gelatin useful in the present invention preferably has an isoelectric point of at least 8, preferably of at least 8.5, and more preferably of at least 8.8. Finally, the modified gelatin can be also characterized in terms of its jelly strength and viscosity average molecular weight. The jelly strength can be determined, for example, by measuring a load used to press down the surface of an aqueous solution of gelatin, which had been cooled in a specific jelly-cup made of glass, with a specific plunger. The modified gelatin useful in the present invention preferably has a jelly strength value of at least 100, preferably of at least 120. Viscosity average molecular weights of modified gelatin used in the present invention can be determined by methods known in the art, such as, for example, the method disclosed by A. Courts and G. Stainsby, “Evidence for Multi-Chain Gelatin Molecules” in “Recent advances in Gelatin and Glue research”, Pergamon Press (1958), pp.100-105. The viscosity average molecular weight is preferably in the range from about 15,000 to about 50,000, preferably from about 17,000 to about 35,000. If these values exceed the upper limits of these ranges, the viscosity of a dispersion of the alumina hydrate and the acid-processed gelatin becomes high, and insoluble matter may be observable in some cases in the dispersion. If the values are lower than the lower limits of these ranges on the other hand, the gelatin does not form a gel, or, if it does so, the gel is very soft and near liquid, and so a dispersion containing such a gelatin undergoes leveling and sags during the drying process. In addition, since the dispersion becomes low in its film-forming ability, the resulting ink-receiving layer tends to crack before and/or after printing.

The recording medium of the present invention has an ink-receiving layer comprising alumina hydrate that may be represented by the formula Al₂O₃nH₂O. Specifically, it may, for example, be gibbsite, bayerite, nordostrandite, boehmite, diaspore or pseudoboehmite. Alumina hydrate, and in particular boehmite or pseudo-boehmite, (wherein n is from 1.0 to 2.0) is preferably used in the recording medium of the present invention. Especially when the alumina hydrate is boehmite or pseudo-boehmite, the gel product, obtainable by evaporating the solvent from the sol, has a good absorbing property and is excellent in the transparency, whereby it is suitable for application to an ink-absorbing layer for a recording sheet. Said alumina hydrate, as described for example in EP patent application No. 636,489, can be produced by any conventional method such as the hydrolysis of aluminum alkoxide or sodium aluminate. Rocek, et al. [Collect Czech. Chem. Commun., Vol. 56, 1253-1262 (1991)] have reported that the pore structure of aluminum hydroxide is affected by deposition temperature, pH of the solution, aging time and surfactants used. The shape of the alumina hydrate used in the present invention can be in the form of a needle or in the form of a flat plate (as described in the literature by Rocek J., et al., Applied Catalysis, Vol. 74, 29-36 (1991), the latter being particularly preferred for the reasons that better dispersibility can be obtained and because the orientation of particles of the alumina hydrate in the form of a flat plate becomes random when forming an ink-receiving layer, so that the range of the pore radius distribution widens. The average particle diameter of the alumina hydrate is preferably higher than 50 nm, more preferably from 50 to 200 nm, and most preferably from 75 to 150 nm.

The BET specific surface area of the alumina hydrate was calculated in accordance with the method described in Brunauer, et al., J. Am. Chem. Soc., Vol. 60, 309 (1938). The BET specific surface areas may preferably be within a range of from 70 to 300 m²/g, more preferably in the range from 100 to 250 m²/g. If the BET specific surface area is greater than the upper limit of the above range a dye in an ink cannot be fully adsorbed and fixed. On the other hand, specific surface areas smaller than the lower limit of the above range allow neither to apply the pigment with good dispersibility nor to control the pore radius distribution.

The pore radius and pore volume of the alumina hydrate were calculated in accordance with the method described in Barrett, et al., J. Am. Chem. Soc., Vol. 73, 373 (1951). The average pore radius of the alumina hydrate preferably is in the range of from 2 to 100 nanometers, more preferably from about 5 to about 50 nanometers. The pore volume of the alumina hydrate is preferably within a range of from 0.7 to 1.0 ml/g. If the pore volume of the alumina hydrate is greater than the upper limit of the above range, cracking and dusting occur on the ink-receiving layer. If the pore volume is smaller than the lower limit of the above range, the resulting recording medium is deteriorated in ink absorption capability.

The content of the gelatin in the dispersion is preferably within a range of from 1 to 49%, more preferably from 3 to 40%, most preferably from 5 to 30% in terms of solid concentration. Vice versa, the content of alumina hydrate in the dispersion is preferably within a range of from 51 to 99%, more preferably from 60 to 97%, most preferably from 70 to 95% in terms of solids concentration. If the solids concentration of gelatin at a usual cooling temperature (4 to 25° C.) upon the coating is lower than the lower limit of the above range, the gelation (setting ability) of the gelatin becomes insufficient, and so the dispersion undergoes leveling and sags. On the other hand, if the solids concentration of gelatin exceeds the upper limit of the above range, the viscosity of the dispersion becomes too high to apply the dispersion.

The dispersion comprising principally the alumina hydrate and the modified gelatin may optionally contain dispersants for the alumina hydrate, viscosity modifiers, pH buffering agents, lubricants, flowability modifiers, surfactants, antifoaming agents, water-proofings, foaming agents, penetrants, coloring dyes, optical whitening agents, ultraviolet absorbents, antioxidants, antiseptics and mildew proofing agents. It is preferred that the dispersion comprise at least 90% by weight of solids of the alumina hydrate and the modified gelatin.

The base material may, by way of non-limiting examples, be selected from paper webs such as suitably sized paper, water leaf paper and resin-coated paper, sheet-like substance such as thermoplastic films, and cloths. No particular limitation is imposed on the base material. In the case of the thermoplastic films, may be used transparent films such as films of polyester, polystyrene, polyvinyl chloride, polymethyl methacrylate, cellulose acetate, polyethylene and polycarbonate, as well as opaque sheets opacified by the filling of an alumina hydrate or the formation of minute foams. When the resin-coated paper is used as the base material, the recording medium according to the present invention can be provided as a recording medium having the same feeling to the touch, stiffness and texture as those of a standard photoprint. Furthermore, the recording medium according to the present invention becomes very close to the standard photoprint because its ink-receiving layer has high surface gloss.

The base material may be subjected to various treatments to enhance its physical properties. For example, a surface treatment, such as a corona discharge treatment, or a high energy treatment, such as a laser treatment, can be conducted for improving the base material adhesiveness to the ink-receiving layer. The base material may also be provided with an adhesion improving layer as an under coat. Further, a curl-preventing layer such as a resin layer or a pigment layer may be provided on the back surface of the base material or at a desired position thereof to prevent curling.

The ink-receiving layer is formed by applying a dispersion comprising the alumina hydrate and the modified gelatin onto a base material by means of a coater and then drying the base material.

As a coating process, may be used a blade coating system, air-knife coating system, roll coating system, brush coating system, gravure coating system, kiss coating system, extrusion system, slide hopper (slide bead) system, curtain coating system, spray coating system, or the like. However, the kiss coating system, extrusion system, slide hopper system and curtain coating system, which are used as coating systems for photographic materials, are preferred in that a thick ink-receiving layer is formed by making good use of the sol-gel conversion (setting ability) of the gelatin. The extrusion system and slide hopper system are particularly preferred in that a coat of proper and uniform thickness is provided.

The viscosity of the resulted dispersion is suitable for the use of a slide hopper system where the coating mixture is run onto a base material (plastic film or paper) in a laminar form. Then, the dispersion can be converted into its jelly form by the action of cold air blown onto the layer and dried in mild conditions, providing a thick layer with a glossy uniform surface on the finished product.

The following examples will describe in particular the advantages of the present invention over the prior art.

### EXAMPLES

An alumina hydrate in a boehmite form was synthesised according to the conventional method of hydrolysis of an aluminium alkoxide as follows.

Into a glass reactor having a capacity of 2 liters (a baffle-equipped separable flat bottom flask, equipped with a stirrer, a thermometer and a condenser), 900 g of deionized water and 751 g of isopropanol were charged and heated to a liquid temperature of 75° C. by a mantle heater. With stirring, 204.5 g of aluminum isopropoxide was added thereto, and the mixture was hydrolized under a stirring speed of 600 rpm at a liquid temperature of from 75 to 80° C. for a time of from 20 to 120 hours. Then, while adding 400 g of deionized water, isopropanol used as the solvent and isopropanol formed by the hydrolysis were distilled off. As a result, a boehmite slurry having a solid content of 10% wt was obtained. At that time, the liquid temperature became 95° C. Then, 6g of acetic acid was added thereto to conduct peptization while maintaining the temperature at 95-97° C. for a time of from 24 to 72 hours. After this step, the boehmite slurry was subjected to spray drying to obtain a powder. A boehmite with the following physical properties (measured in the form of an aqueous dispersion) was obtained:

| | | |
|---|---|---|
| Average particle size | 100 | nm |
| BET specific surface area | 190 | m²/g |
| Average pore radius | 11 | nm |
| Pore volume | 0.7-1.0 | ml/g |

### Example 1

### Preparation of Gelatin Samples

Gelatin 1 (Comparison). A pig-skin acid processed gelatin (YG1 tradename, manufactured by SKW) was selected.

Gelatin 2 (invention). The Gelatin 1 was modified according to the present invention as follows. A 3-liter, 4-necks Morton type flask fitted with a mechanical stirrer, a thermometer, and a condenser was charged with methanol (1650 g) and concentrated HCl (2.1 g). The mixture was stirred (150 rpm) at reflux (65° C.) and 600 g of a 15% aqueous solution of gelatin was added thereto. The mixture was stirred at the new reflux temperature (about 70° C.) for 72 hours, then 1710 g of solvent was distilled off. The solution of gelatin obtained was deionized by means of ionic exchange resins (IR-120B and IRA 401 manufactured by Amberlite Co.), filtered and dried.

Gelatin 3 (invention). The Gelatin 1 was modified in the same manner as in Sample 2, except that the mixture was stirred at reflux (about 70° C.) for 48 hours.

Gelatin 4 (invention). The Gelatin 1 was modified in the same manner as in Sample 2, except that the mixture was stirred at reflux (about 70° C.) for 24 hours.

Gelatin 5 (invention). The Gelatin 1 was modified in the same manner as in Sample 2, except that the mixture was stirred at reflux (about 70° C.) for 12 hours.

Gelatin 6 (comparison). The Gelatin 1 was hydrolysed in the following manner. A 3-liter, 4-necks Morton type flask fitted with a mechanical stirrer, a thermometer, and a condenser was charged with deionized water (1650 g) and concentrated HCl (2.1 g). The mixture was stirred (150 rpm) at 65° C. and 600 g of a 15% aqueous solution of gelatin was added thereto. The mixture was stirred at 70° C. for 72 hours, then 1710 g of water was distilled off. The solution of gelatin obtained was deionized by means of ionic exchange resins (IR-120B and IRA 401 manufactured by Amberlite Co.), filtered and dried.

Gelatin 7 (comparison). The Gelatin 1 was hydrolysed in the same manner as in Sample 6, except that the mixture was stirred at 70° C. for 48 hours.

Gelatin 8 (comparison). The Gelatin 1 was hydrolysed in the same manner as in Sample 6, except that the mixture was stirred at 70° C. for 24 hours.

Gelatin 9 (comparison). The Gelatin 1 was hydrolysed in the same manner as in Sample 6, except that the mixture was stirred at 70° C. for 12 hours.

Gelatin 10 (comparison). An alkali processed bone gelatin (3M Blend tradename, manufactured by SKW) was selected.

Gelatin 11 (comparison) was prepared as Gelatin 4, but modifying the alkali bone processed Gelatin 10 rather than the acid processed Gelatin 1.

Gelatin 12 (comparison) was prepared as Gelatin 2, but modifying the alkali bone processed Gelatin 10 rather than the acid processed Gelatin 1.

Gelatin 13 (comparison). An alkali bone processed gelatin (Solugel™ LB tradename, manufactured by PB Gelatins) was selected.

The obtained gelatins have been characterized with the following techniques.

Viscosity average molecular weight. The method used herein is developed from what described in “Recent advances in Gelatin and Glue research”, Pergamon Press (1958), p. 100-105; the apparatus used is a Ubbelohde 53101—Schott Gerate viscometer in a Viscosystem AVS400—Schott Gerate automatic viscosity measuring system at a temperature of 40° C. 50 ml of a reference solution 2.0 M sodium chloride were put in a 100 ml measuring flask and heated at 40° C. Thereafter water was added to reach the volume of 100 ml. The time the reference solution spent to flow-down into the capillary viscosimeter (T₀) was measured. 0.25 g of dry gelatin were put in a 100 ml measuring flask, to which 50 ml of a solution 2.0 M sodium chloride where added, thereby fully swelling the gelatin. Thereafter the gelatin was completely dissolved at 45° C. and water was added (at 40° C.) to reach a volume of 100 ml, so that its concentration (C) is 0.25 g/dl. The time the gelatin solution spent to flow-down into the capillary viscosimeter (T) was measured. The Limiting Viscosity Number (LVN) was obtained using the formula LVN=(1 n T/T₀)/C. The viscosity average molecular weight (Mvisc.) was calculated used the following equation LVN=2.97*10⁻³ Mvisc.^{0.45}, as disclosed in “Macromolecular Chemistry of gelatin”, A. Veis, Academic Press (1964), p.77.

Iso-Electric Point (IEP). 5 ml of a cation exchange resin (IR-120B, produced by Amberlite Co.) and 10 ml of an anion exchange resin (IRA-401, produced by Amberlite Co.) were mixed and evenly packed in a column warmed by adding 100 ml of water at 45° C. 100 ml of a 1% aqueous solution of gelatin was passed through the column at a rate of 50 ml/hour. After removal of 25 ml initial effluent from the column, 50 ml of effluent was collected at a liquid temperature of 35° C. and its pH was measured by a pH-meter Orion Research Meter 811.

Jelly Strength. Jelly Strength was determined by a LFR Texture Analyser (produced by Stevens), by measuring the load needed to press down by 4 mm with a specific plunger the surface of a 6.66% aqueous solution of gelatin, which had been cooled to 10° C. in a specific jelly-cup made of glass.

The results are reported in Table 1.

TABLE 1

| | Viscosity average | IsoElectric | Jelly |
|---|---|---|---|
| Gelatin Nos. | molecular weight | Point | Strength (g) |
| 1 (Comparison) | 74601 | 9.30 | 322 |
| 2 (Invention) | 17754 | 8.87 | 122 |
| 3 (Invention) | 18105 | 8.90 | 135 |
| 4 (lnvention) | 26143 | 8.96 | 183 |
| 5 (Invention) | 29063 | 9.40 | 195 |
| 6 (Comparison) | 6250 | 6.35 | 63 |
| 7 (Comparison) | 8151 | 6.74 | 72 |
| 8 (Comparison) | 10947 | 6.82 | 88 |
| 9 (Comparison) | 15373 | 7.01 | 107 |
| 10 (Comparison) | 114020 | 5.00 | 244 |
| 11 (Comparison) | 72900 | 7.10 | 195 |
| 12 (Comparison) | 8397 | 5.70 | 78 |
| 13 (Comparison) | 4196 | 5.00 | 25 |

### Example 2

### Preparation of Recording Sheets

Coating liquids 1 to 13 were obtained by mixing 35 g of an aqueous solution containing 10% of, respectively, the Gelatins 1 to 12 and a variable amount (as detailed in Table 2) of the boehmite sol having a sol content of 22%.

Samples 2 to 5 (invention) were obtained by coating, respectively, the liquids 2 to 5 onto a resin coated paper by means of a bar coater so that the coated amount after drying would be 35 g/m². The layer was first gelled at 4° C. and then dried at 25° C.

Samples 1, 8, 9, 10 and 11 (comparison). The coating liquids 1, 8, 9, 10 and 11 were not coatable onto a resin coated paper, since coagulation and disomogeneity were present into the final dispersion.

Samples 6, 7, 12 and 13 (comparison) were obtained by coating, respectively, the coating liquids 6, 7, 12 and 13 onto a resin coated paper by means of a bar coater. Due to the fact that said coating liquids had no sol-gel reversibility, the samples have been dried at 80° C., so that it has not been possible to get a layer of proper thickness (35 g/m²) and free of surface defects.

The obtained sheets were printed with an Epson Stylus Color 980 printer.

On the sheets obtained the following printing tests were performed:

Drying time: Drying time was evaluated by printing continuous bars of black, cyan, magenta, yellow, red, green and blue. Immediately after the printed sheet was ejected from the printer, it was placed face up on a foam rubber mat. A standard piece of bond paper was placed over the printed area and a smooth metal cylinder was rolled quickly but smoothly and continuously over the bond paper surface. The bond paper was immediately separated from the printed page of interest and the test was ranked as follow: “AA” if no ink at all transferred onto the paper, “A” if there was trace of one ink on the paper, “B” if there were traces of more than one ink on the paper.

Mottling and Bleeding: The mottle test was performed by visual inspection of the samples. The bleeding test was performed allowing the entire recording medium (carrying a suitable image) to stand for 24 hours at a temperature of 60° C. and a humidity of 85% and evaluating the inter-diffusion of colors. The test was ranked “AA” if neither mottling nor bleeding occur and the image quality was excellent, “A” if the image quality was good, and “B” if bleeding or mottling are present in the printed image.

Optical density: Optical density was measured on solid patches of yellow, cyan magenta and black by means of a Macbeth reflection densitometer. It was reported a media of the optical density values for the four inks.

Glossiness: Glossiness was measured (both on a white area and on printed area) at an angle of 85° to the perpendicular to the plane of the coating using a TRI-Microgloss-160 (Produced by Sheen) as disclosed in ASTM standard No.523.

The obtained results are shown in Table 2.

TABLE 2

| | | | | | | | | Glossi- | Glossi- | |
|---|---|---|---|---|---|---|---|---|---|---|
| Recording | | 22% | Boehmite/ | | | | | ness | ness | |
| sheet | Gelatin | boehmite | gelatin | | Drying | Mottle | Optical | printed | white | Cracking |
| Samples Nos. | Nos. | sol. (g) | ratio | Coatable | time | Bleeding | density | area | area | Defects |
| 1 (comparison) | 1 | 80 | 5:1 | NO | | | | | | |
| 2 (invention) | 2 | 80 | 5:1 | YES | AA | AA | 2.17 | 77 | 78 | NO |
| 3 (invention) | 3 | 39.78 | 2.25:1 | YES | A | AA | 2.08 | 77 | 78 | NO |
| 4 (invention) | 4 | 23.84 | 1.5:1 | YES | A | A | 2.07 | 78 | 79 | NO |
| 5 (invention) | 5 | 15.90 | 1.1 | YES | A | A | 2.03 | 80 | 81 | NO |
| 6 (comparison) | 6 | 80 | 5:1 | YES | | | | | | YES |
| 7 (comparison) | 7 | 80 | 5:1 | YES | | | | | | YES |
| 8 (comparison) | 8 | 80 | 5:1 | NO | | | | | | |
| 9 (comparison) | 9 | 80 | 5:1 | NO | | | | | | |
| 10 (comparison) | 10 | 80 | 5:1 | NO | | | | | | |
| 11 (comparison) | 11 | 80 | 5:1 | NO | | | | | | |
| 12 (comparison) | 12 | 80 | 5:1 | YES | | | | | | YES |
| 13 (comparison) | 13 | 80 | 5:1 | YES | | | | | | YES |

Table 2 shows that the recording sheet Samples 2 to 5 of the present invention, obtained by coating a dispersion of alumina hydrate and an acid-processed gelatin modified by an alkyl esterification method, are coatable, present good results in terms of drying time, mottle, bleeding, optical density and glossiness, and do not have cracking defects or microcoagulations. On the other hand, Sample 1, obtained by using a non-modified acid-processed gelatin, Samples 8 and 9, obtained by using an acid-processed gelatin modified by a method different from the method described in the present invention, Sample 10, obtained by using an alkali-processed gelatin and Sample 11, obtained by using an alkali-processed gelatin modified by an alkyl esterification method, present coagulation and disomogeneity into the final dispersion, not allowing the coatability onto a resin coated paper. In addition, Samples 6, obtained by using an acid-processed gelatin modified by a method different from the method described in the present invention, and Samples 12 and 13, obtained by using an alkali-processed gelatin, are coatable, but show several cracking defects in the ink-receiving layer and does not allow to get the proper thickness.

1. Recording medium having an ink-receiving layer which comprises an alumina hydrate and an acid-processed gelatin, wherein said acid-processed gelatin comprises at least some blocked carboxylic groups.

2. Recording medium according to claim 1, wherein the acid-processed gelatin comprises alkyl esterified carboxylic groups.

3. Recording medium according to claim 1, wherein the acid-processed gelatin comprises methyl esterified carboxylic groups.

4. Recording medium according to claim 1, wherein the acid-processed gelatin has an isoelectric point of at least 8.

5. Recording medium according to claim 1, wherein the acid-processed gelatin has an isoelectric point of at least 8.5.

6. Recording medium according to claim 1, wherein the acid-processed gelatin has an isoelectric point of at least 8.8.

7. Recording medium according to claim 1, wherein the acid-processed gelatin has a jelly strength value of at least 100.

8. Recording medium according to claim 1, wherein the acid-processed gelatin has a jelly strength value of at least 120.

9. Recording medium according to claim 1, wherein the acid-processed gelatin has a viscosity average molecular weight in the range from about 15,000 to about 50,000.

10. Recording medium according to claim 1, wherein the acid-processed gelatin has a viscosity average molecular weight in the range from about 17,000 to about 35,000.

11. Recording medium according to claim 1, wherein the acid-processed gelatin comprises a percentage of blocked carboxylic groups of at least 10% relative to the number of original free carboxylic groups.

12. Recording medium according to claim 1, wherein the acid-processed gelatin comprises a percentage of blocked carboxylic groups of at least 20% relative to the number of original free carboxylic groups.

13. Recording medium according to claim 1, wherein the alumina hydrate has a boehmite or pseudo-boehmite structure of formula Al₂O₃nH₂O, wherein n is a number from 1.0 to 2.0.

14. Recording medium according to claim 1, wherein the average particle diameter of the alumina hydrate is higher than 50 nm.

15. Recording medium according to claim 1, wherein the pore volume of the alumina hydrate is within a range of from 0.7 to 1.0 ml/g.

16. Recording medium according to claim 1, wherein said ink-receiving layer comprises an amount of said acid-processed gelatin within a range of from 1 to 49% and an amount of said alumina hydrate within a range of from 51 to 99% in terms of solids concentration.
